(19) United States
(12) Patent Application Publication
(10) Pub. No.: US 2024/0342669 A1
(43) Pub. Date: Oct. 17, 2024

(54) Agitator device, agitation system and method for operating an agitation system

(71) Applicant: EKATO RÜHR- UND MISCHTECHNIK GMBH, Schopfheim (DE)

(72) Inventors: Benjamin MULTNER, Wehr (DE); Wolfgang LAST, Lörrach (DE)

(21) Appl. No.: 18/683,336

(22) PCT Filed: Aug. 8, 2022
(86) PCT No.: PCT/EP2022/072245

§ 371 Date: Feb. 13, 2024

(30) Foreign Application Priority Data
Aug. 13, 2021 (DE) 10 2021 121 103.4

(51) Int. Cl. B01F 27/09; B01F 35/30; F16C 17/02

(52) U.S. Cl. CPC B01F 27/09; F16C 17/02; B01F 2035/352; F16C 2206/04

(57) ABSTRACT

An agitator device has at least one intermediate bearing which is configured for supporting an agitation shaft within an agitation tank and which has a first bearing element and a second bearing element which, in an operation state, is rotatable relative to the first bearing element around a bearing axis and is in contact with the first bearing element,
wherein at least one of the bearing elements has polycrystalline diamond.

### CORRESPONDENCE TO RELATED APPLICATIONS

This patent application is based on and incorporates herein by reference the German patent application DE 10 2021 121 103.4, filed on Aug. 13, 2021, and the international patent application PCT/EP2022/072245, filed on Aug. 8, 2022.

### PRIOR ART

The invention relates to an agitator device, to an agitation system, and to a method for operating an agitation system.

The prior art has already disclosed agitators in which an agitation shaft of the agitator is supported by means of at least one agitator bearing. It can be expedient, in particular in the case of very long agitation shafts, for the agitation shaft to be supported by means of an additional intermediate bearing in an agitation tank. Here, the intermediate bearing is generally designed as a plain bearing for accommodating radial forces and comprises a first bearing bushing, which is fixedly connected to a housing, and a second bearing bushing, which is connected to the agitation shaft, wherein the bearing bushings have running partners which are in contact with one another during operation. Since, during operation, the intermediate bearing is situated within the medium to be agitated, which medium may also have corrosive and/or abrasive properties and be at high temperatures depending on the application, particularly stringent demands are placed on the materials of the intermediate bearing, which materials must be selected in accordance with the expected increased erosion and/or corrosion loads and corresponding operating temperatures. Depending on the application, use has hitherto been made of bearing bushings whose running partners are formed from glass-fiber-reinforced polytetrafluoroethylene (PTFE) and/or high-grade steel, which for abrasive conditions may be provided with a hard layer consisting for example of chromium oxide or tungsten carbide. In the case of elevated operating temperatures and/or corrosive environments, use is predominantly made of bearing bushings having running partners consisting of carbon and/or graphite. For extreme conditions, for example for the agitation of highly concentrated gypsum suspensions, the running partners may be formed for example from silicon carbide. A disadvantage of all previously known intermediate bearings for supporting agitation shafts in agitation tanks is that they are not designed for dry running, such that, for a commencement of operation of the agitator when no hydrodynamic lubrication is provided between the running partners by the medium, bearing bushings consisting of plastic must initially be used, which, before the commencement of proper operation, must be exchanged for the bearing bushings consisting of the materials mentioned above, resulting in considerable additional effort and thus additional costs for the commencement of operation. Furthermore, conventional intermediate bearings exhibit high levels of wear owing to their materials, resulting in shortened service lives and increased maintenance and repair effort for the intermediate bearings. Furthermore, conventional intermediate bearings for high-temperature applications with running partners consisting of carbon and/or graphite can withstand only very low contact pressures, necessitating a large structural height of the intermediate bearings in order to withstand the occurring contact pressures. This in turn leads to considerable additional costs for the further components of the intermediate bearing, for example the bearing housing, which are often produced from chemically particularly durable and thus expensive materials, for example titanium.

It is the object of the invention in particular to provide a generic device having advantageous properties with regard to efficiency. The object is achieved according to the invention.

### Advantages of the Invention

The invention proceeds from an agitator device having at least one intermediate bearing which is configured for supporting an agitation shaft within an agitation tank and which has a first bearing element and a second bearing element which, in an operation state, is rotatable relative to the first bearing element around a bearing axis and is in contact with the first bearing element.

It is proposed that at least one of the bearing elements has polycrystalline diamond.

By means of such an embodiment, it is advantageously possible to provide an agitator device that exhibits improved efficiency. In particular, an agitator device having particularly high mechanical load capacity and particularly good chemical durability is provided, whereby advantageously long service lives and low-maintenance operation can be achieved. Owing to the very high mechanical load capacity of polycrystalline diamond, it is furthermore advantageously possible to provide an intermediate bearing that has a reduced structural height in relation to previously known intermediate bearings. In this way, material efficiency can advantageously be improved, in particular by virtue of the fact that further components of the intermediate bearing, for example a bearing housing, which in an operation state are in contact with media situated within an agitation tank and which must accordingly be chemically particularly durable and thus produced in part from very expensive materials, for example titanium, depending on the application, can be of correspondingly smaller dimensions.

An “agitator device” is to be understood to mean at least a part and/or an assembly, in particular a subassembly, of an agitation system, in particular of a reactor. The agitator device may also encompass the entire agitation system.

The intermediate bearing is configured for supporting the agitation shaft within an agitation tank, and has the first bearing element, the second bearing element and a bearing housing. The intermediate bearing may also have further components. In the operation state, the second bearing element is rotatable around the bearing axis relative to the first bearing element, wherein the bearing axis is preferably parallel to an axis of rotation of the agitation shaft and particularly preferably congruent with the axis of rotation of the agitation shaft. The first bearing element is preferably formed as a stationary bearing element and connected, in particular rotationally fixedly, to the bearing housing. The first bearing element could be cohesively connected to the bearing housing, for example by welding. The first bearing element is preferably connected form-fittingly and/or frictionally, and in particular detachably, to the bearing housing, for example by means of a screw connection and/or a tongue-and-groove connection and/or a parallel key and/or fastening pins and/or the like. The second bearing element is preferably designed as a movable bearing element and connected to the agitation shaft when the agitator device is in an assembled state. The second bearing element could be cohesively connected to the agitation shaft, for example welded to the agitation shaft, in the assembled state. The second bearing element is preferably connected form-fittingly and/or frictionally, and in particular detachably, to the agitation shaft in the assembled state. It would for example be conceivable for the second bearing element to be shrink-clamped onto, and hereby frictionally connected to, the agitation shaft. It is however particularly preferable for the intermediate bearing to have a shaft sleeve for a form-fitting and/or frictional connection of the second bearing element to the agitation shaft, wherein the second bearing element, in the assembled state, lies with a first side against a shaft shoulder of the agitation shaft in an axial direction of the agitation shaft, and, on a second side situated opposite the first side, the shaft sleeve adjoins the second bearing element in an axial direction of the agitation shaft and holds said second bearing element in position in an axial direction. The shaft sleeve is preferably connected to the bearing housing, for example by means of a screw connection or the like. The first bearing element has a first base body and at least one first contact element, preferably a multiplicity of first contact elements. The second bearing element has a second base body and at least one second contact element, preferably a multiplicity of second contact elements. The first contact element of the first bearing element and the second contact element of the second bearing element are configured for performing a relative movement, in particular a rotational movement around the bearing axis, with respect to one another in the operation state, and in the process being at least intermittently in contact with one another. In the operation state, the first bearing element, in particular the at least one first contact element of the first bearing element, and the second bearing element, in particular the at least one second contact element of the second bearing element, may be in contact directly or indirectly, that is to say via a lubricating film consisting of lubricant in the case of hydrostatic or hydrodynamic lubrication. The contact elements of the respective bearing elements could be formed integrally with the relevant base body of the relevant bearing element, and for example form a part of a surface of the relevant base body and/or be applied as a coating to the relevant base body. The term “integrally” is to be understood to mean at least cohesively connected, for example by way of a welding process, an adhesive bonding process, an overmolding process, a coating process and/or some other process that appears expedient to a person skilled in the art, and/or advantageously formed in one piece, for example by production from one casting and advantageously from a single blank. The respective contact elements are preferably formed separately from the relevant base body and fixedly connected to the relevant base body, for example pressed form-fittingly and/or frictionally into corresponding recesses in the base body. The first bearing element and/or the second bearing element have polycrystalline diamond and could in particular be formed entirely from polycrystalline diamond. The first base body of the first bearing element and/or the second base body of the second bearing element are/is however preferably formed from a material other than polycrystalline diamond, for example from a metal and/or a metal alloy such as high-grade steel or titanium or Hastelloy, preferably titanium. It is preferable for the at least one first contact element of the first bearing element and/or the at least one second contact element of the second bearing element to be formed from polycrystalline diamond. In the present document, “polycrystalline diamond” (PCD) refers to a material which is produced synthetically, in particular by a sintering process at high pressure and high temperature, and which has a metal matrix, consisting for example of cobalt, in which there is arranged an intergrown structure of, in particular synthetically produced, diamond particles.

In the present document, the phrase “at least substantially” is to be understood to mean that a deviation from a specified value amounts to less than 25%, preferably less than 10% and particularly preferably less than 5% of the specified value.

In the present document, numerical words such as “first” and “second” that precede certain terms are used merely for distinction between objects and/or assignment of objects to one another, and do not imply a total number and/or sequence of the objects. In particular, a “second object” does not imperatively imply the presence of a “first object”.

The term “configured” is to mean specifically designed and/or equipped. The statement that an object is configured for a particular function is to be understood to mean that the object satisfies and/or performs this particular function in at least one state of use and/or operation state.

The first bearing element or the second bearing element could be formed without polycrystalline diamond. For example, it would be conceivable for the first contact element of the first bearing element or the second contact element of the second bearing element to be produced from the same material as the relevant base body of the relevant bearing element. It would also be conceivable for the first contact element of the first bearing element or the second contact element of the second bearing element to be formed from a material other than polycrystalline diamond, for example from polytetrafluoroethylene (PTFE) and/or from tungsten carbide and/or chromium oxide and/or from silicon carbide and/or from boron nitride and/or from some other material that appears expedient to a person skilled in the art. In one advantageous embodiment, it is however proposed that both bearing elements have polycrystalline diamond. It is hereby advantageously possible to provide an intermediate bearing that has particularly high mechanical load capacity. It is thus advantageously possible to further increase an efficiency of the agitator device and achieve a particularly long service life of the intermediate bearing. It is preferable for the at least one first contact element of the first bearing element and the at least one second contact element of the second bearing element to each be formed from polycrystalline diamond.

It is furthermore proposed that the intermediate bearing is designed for dry running. Efficiency can be further improved by means of such an embodiment. In particular, a simplified and fast commencement of operation of an agitation system having an agitator device can be achieved if the intermediate bearing is designed for dry running, because the intermediate bearing can be set in operation in a dry-running state without hydrostatic or hydrodynamic lubrication between the bearing elements, thus eliminating the otherwise necessary use and subsequent exchange of bearing bushings consisting of plastics during the commencement of operation. During dry running, the at least one first contact element of the first bearing element and the at least one second contact element of the second bearing element are at least intermittently in direct mechanical contact, that is to say without a lubricating film between the first contact element and the second contact element. The intermediate bearing is furthermore designed for wet running, with a lubricating film between the contact elements. The intermediate bearing is preferably designed as a hydrodynamic plain bearing in which, in the operation state, a lubricating film is formed between the first contact element of the first bearing element and the second contact element of the second bearing element by a medium that is situated within the agitation tank. It is alternatively also conceivable in principle for the intermediate bearing to be designed as a hydrostatic plain bearing and to have at least one lubricant circuit comprising a pump for feeding a lubricant, which differs from the medium in the agitation tank, into a bearing gap between the first bearing element and the second bearing element.

It is furthermore proposed that a coefficient of friction between the first bearing element and the second bearing element during dry running is at most 0.08. Dry running with particularly low frictional wear can thus advantageously be made possible. A particularly reliable and durable intermediate bearing can thus be provided. In particular, the coefficient of friction between the first bearing element and the second bearing element during dry running is at most 0.07, advantageously at most 0.06, particularly advantageously at most 0.05, preferably at most 0.04 and particularly preferably at most 0.03. During wet running with hydrodynamic lubrication, the coefficient of friction between the first bearing element and the second bearing element is negligibly low, and is in particular at most 0.002.

It is furthermore proposed that the first bearing element and the second bearing element have a compressive strength of at least 5.0 GPa. By means of such an embodiment, it is advantageously possible to provide an intermediate bearing which can withstand a particularly high contact pressure, whereby a structural height of the intermediate bearing can be significantly reduced in relation to conventional intermediate bearings for high-temperature applications comprising contact elements consisting of carbon and/or graphite. This advantageously also yields material savings and thus cost savings, in particular owing to the fact that the intermediate bearing can be of smaller overall dimensions, and thus material costs for further components of the intermediate bearing, for example for the bearing housing, are correspondingly lower. The first bearing element and the second bearing element have in particular a compressive strength of at least 5.5 GPa, advantageously of at least 6 GPa, particularly advantageously of at least 6.5 GPa, preferably of at least 7.0 GPa and particularly preferably of at least 7.5 GPa.

It is furthermore proposed that the first bearing element and the second bearing element have a thermal conductivity of at least 400 W/mK. Particularly good heat dissipation can thus advantageously be achieved. It is advantageously possible, in particular during the starting and stoppage of a rotational movement of the agitation shaft and during dry running, for the likelihood of undesired local friction welding between the contact elements of the first and the second bearing element, which leads to scoring and abrasion, to be reduced, preferably minimized. It is thus possible for a durability of the intermediate bearing to be further improved, and for particularly efficient operation to be made possible. The first bearing element and the second bearing element have in particular a thermal conductivity of at least 425 W/mK, advantageously of at least 450 W/mK, particularly advantageously of at least 475 W/mK, preferably of at least 500 W/mK and particularly preferably of at least 525 W/mK.

It is furthermore proposed that the intermediate bearing has a heat resistance of at least 250° C. It is thus advantageously possible to provide an agitator device for reliable use in high-temperature applications, for example for performing agitation processes and/or chemical reactions at high temperatures. The intermediate bearing has in particular a heat resistance of at least 260° C., advantageously of at least 270° C., particularly advantageously of at least 280° C., preferably of at least 290° C. and particularly preferably of at least 300° C. The expression “heat resistance” refers here and below to the resistance of an object, in particular of a material and/or component, to the effects of temperature, and is characterized by a temperature below which temperature-dependent properties of the object change only insignificantly and only within tolerances that are allowable for the particular use of the object.

It is furthermore proposed that the intermediate bearing is designed as a radial bearing, wherein the first bearing element is designed as a stationary outer ring and the second bearing element is designed as a movable inner ring. By means of such an embodiment, a reliable intermediate bearing for accommodating radial forces can advantageously be provided using particularly simple technical means. Alternatively, the intermediate bearing could in principle also be designed as a radial and axial bearing, wherein the first bearing element could have at least one first radial contact element for accommodating radial forces and at least one first axial contact element, arranged perpendicular to the first radial contact element, for accommodating axial forces, and the second bearing element could have at least one second radial contact element for accommodating radial forces and at least one second axial contact element arranged perpendicular to the second radial contact element.

The invention furthermore relates to an agitation system, in particular a reactor, having an agitation tank and having an agitator device according to any one of the embodiments described above arranged in the agitation tank. Such an agitation system is distinguished in particular by the aforementioned advantageous properties of the agitator device. The agitation system may have further units and/or elements in addition to the agitation tank and the agitator device. The agitation system preferably has an agitator which includes the agitator device and which furthermore has the following, without being restricted to these: the agitation shaft; a drive unit having a drive motor for driving the agitation shaft; and at least one agitation element arranged on the agitation shaft.

The invention furthermore relates to a method for operating the above-described agitation system, wherein the agitation tank is filled with a corrosive and/or abrasive medium. By means of such a method, it is advantageously possible for the agitation system to be operated reliably even in the case of particularly stringent demands being placed on the mechanical and/or chemical durability of, in particular in the presence of an elevated erosion and/or corrosion load on, the agitation system, in particular the agitator device. The method for operating the agitation system may for example be used for the following, without being restricted to these: the production of terephthalic acid, wherein acetic acid that is used as solvent is a corrosive medium; or the preparation of ores, for example for the hydrometallurgical extraction of zinc, nickel or copper using sulfuric acid, wherein the medium, aside from having corrosive properties, may also be abrasive owing to ore particles suspended therein.

It is furthermore proposed that the medium is at a temperature of at least 180° C. In this way, reliable operation of the agitation system can be made possible even in the case of stringent demands being placed on a temperature resistance of the agitation system, in particular of the agitator device. The medium is preferably at a temperature between 190° C. and 210° C. The medium may however also be at temperatures higher than 210° C. For example, in the case of the production of terephthalic acid, it may be necessary for acetic acid to be removed and for the raw terephthalic acid to be dissolved in water at temperatures of approximately 250° C.

Here, it is not the intention for the agitator device according to the invention and the agitation system according to the invention to be restricted to the uses and embodiments described above. In particular, in order to perform a function described herein, the agitator device according to the invention and/or the agitation system according to the invention may have a number of individual elements, components and units that deviates from a number stated herein.

### DRAWINGS

Further advantages will become apparent from the following description of the drawings. The drawings illustrate an exemplary embodiment of the invention. The drawings, the description and the claims contain numerous features in combination. A person skilled in the art will expediently also consider the features individually and combine them to form meaningful further combinations.

In the drawings:

FIG. 1 is a schematic illustration of an agitation system having an agitation tank and having an agitator device arranged in said agitation tank,

FIG. 2 is a schematic perspective view of the agitator device with an intermediate bearing,

FIG. 3 is a schematic sectional illustration of the intermediate bearing,

FIG. 4 is a schematic exploded illustration of a first bearing element and a second bearing element of the intermediate bearing, and

FIG. 5 is a schematic flow diagram of a method for operating the agitation system.

### DESCRIPTION OF THE EXEMPLARY EMBODIMENT

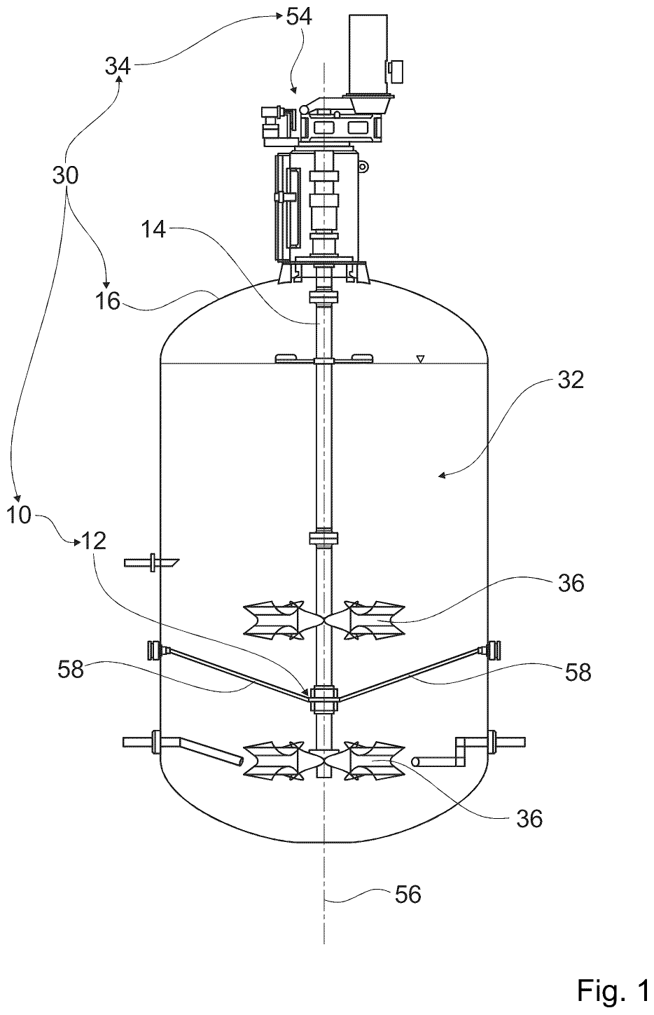

FIG. 1 shows an agitation system 30. The agitation system 30 is designed as a reactor, specifically as an agitation reactor. In the present case, the agitation system 30 is configured for example for the production of terephthalic acid, a precursor of polyesters, for example polyethylene terephthalate (PET). Aside from the production of terephthalic acid, however, the agitation system 30 may also be configured for other uses, for example for the hydrometallurgical preparation of ores.

The agitation system 30 has an agitation tank 16. The agitation tank 16 is configured for receiving at least one medium 32. For the production of terephthalic acid, the medium in the agitation tank 16 may for example include p-Xylene and acetic acid as solvent.

The agitation system 30 comprises an agitator 34 having an agitation shaft 14, having a drive unit 54 for driving the agitation shaft 14, and having agitation elements 36 arranged on said agitation shaft for the purposes of mixing the medium 32. When the agitation system 30 is in an operation state, the drive unit 34 drives the agitation shaft 14 in a rotational movement around an agitation axis 56.

The agitation system 30 comprises an agitator device 10. The agitator device 10 is arranged in the agitation tank 16.

The agitator device 10 comprises at least one intermediate bearing 12. The intermediate bearing 12 is configured for supporting the agitation shaft 14 within the agitation tank 16. The intermediate bearing 12 is connected to the agitation tank 16 via fastening struts 58.

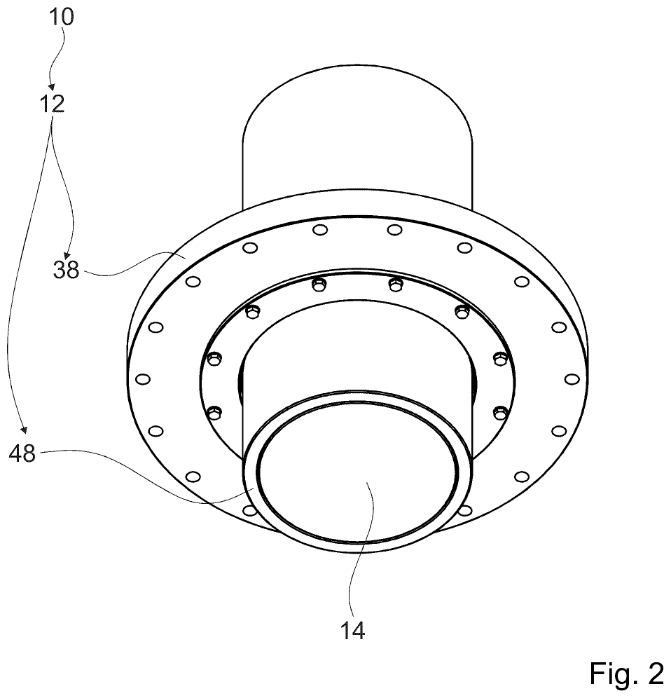

FIG. 2 is a schematic perspective illustration of the agitator device 10 with the intermediate bearing 12. The intermediate bearing 12 has a bearing housing 38. The intermediate bearing 12 has a shaft sleeve 48 which, when the agitator device 10 is in an assembled state, partially surrounds the agitation shaft 14, specifically radially along a portion of the agitation shaft 14 that extends below the bearing housing 38. The shaft sleeve 48 is detachably connected to the bearing housing 38 by means of screw connections.

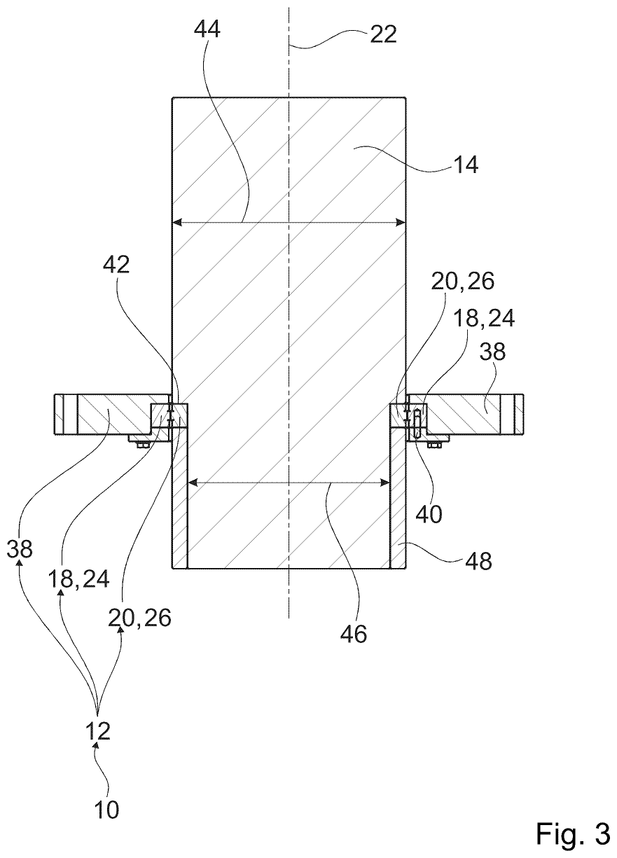

FIG. 3 is a schematic sectional view through the intermediate bearing 12. The section plane of the sectional view shown in FIG. 3 runs parallel to a bearing axis 22 of the intermediate bearing 12. In the present case, the bearing axis 22 is congruent with the agitation axis 56 (cf. FIG. 1) of the agitation shaft 14. The intermediate bearing 12 has a first bearing element 18 and a second bearing element 20. When the agitator device 10 is in an operation state, the second bearing element 20 is rotatable relative to the first bearing element 18 around the bearing axis 22. In the operation state, the second bearing element 20 is in contact with the first bearing element 18.

At least one of the bearing elements 18, 20 has polycrystalline diamond. In the present case, both bearing elements 18, 20 have polycrystalline diamond.

In the present case, the intermediate bearing 12 is designed as a radial bearing. The first bearing element 18 is designed as a stationary outer ring 24. The first bearing element 18 designed as a stationary outer ring 24 is connected to the bearing housing 38, rotationally fixedly in a circumferential direction around the bearing axis 22, by means of fastening pins 40. The second bearing element 20 is designed as a movable inner ring 26. In a direction perpendicular to the bearing axis 22, the second bearing element 20 designed as a movable inner ring 26 is arranged within the first bearing element 18 designed as a stationary outer ring 24.

The agitation shaft 14 has a shaft shoulder 42. Above the shaft shoulder 42, the agitation shaft 14 has a first shaft diameter 44. Below the shaft shoulder 42, the agitation shaft 14 has a second shaft diameter 46 that is smaller than the first shaft diameter 44. In the assembled state, the second bearing element 20 designed as a movable inner ring 26 lies with a top side against the shaft shoulder 42. In the assembled state, the second bearing element 20 is fastened to the agitation shaft 14 in an axial direction along the bearing axis 22 by means of the shaft sleeve 48. A difference between an outer diameter and an inner diameter of the movable inner ring 26 at least substantially corresponds to a difference between the first shaft diameter 44 and the second shaft diameter 46 of the agitation shaft 14. An inner diameter of the stationary outer ring 24 at least substantially corresponds to the first shaft diameter 44 of the agitation shaft 14.

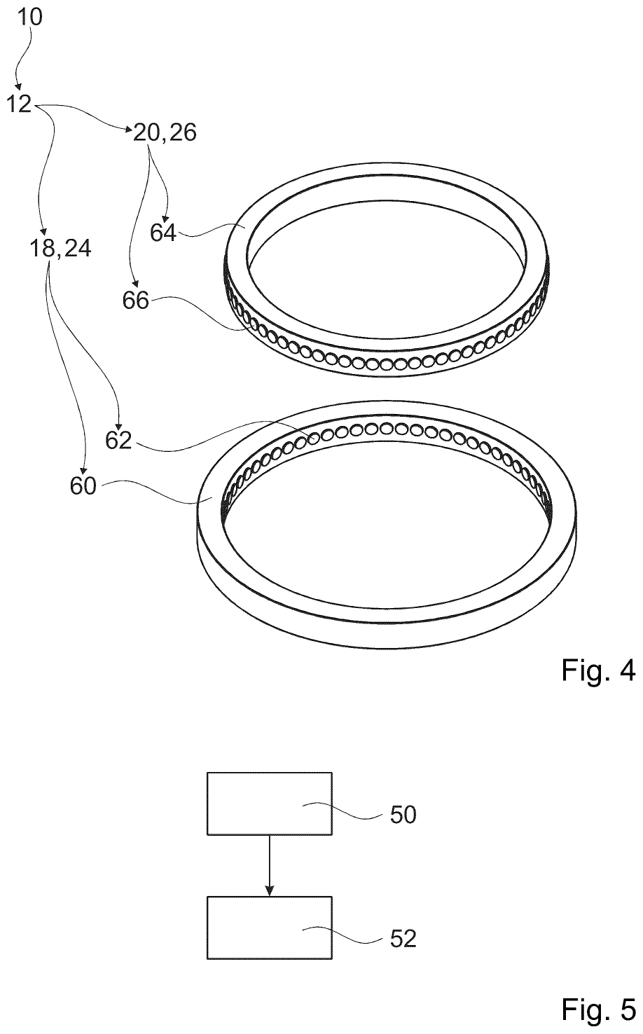

FIG. 4 is a schematic exploded illustration of the first bearing element 18 and the second bearing element 20 of the intermediate bearing 12. The first bearing element 18 designed as a stationary outer ring 24 has a first base body 60. The first bearing element 18 designed as a stationary outer ring 24 has at least one first contact element 62. In the present case, the first bearing element 18 has a multiplicity of first contact elements 62. The first contact elements 62 are evenly spaced apart from one another along a circumferential direction on an inner side of the first base body 62.

The second bearing element 20 designed as a movable inner ring 26 has a second base body 64. The second bearing element 20 designed as a movable inner ring 26 has at least one second contact element 66. In the present case, the second bearing element 20 has a multiplicity of second contact elements 66. The second contact elements 66 are evenly spaced apart from one another on an outer side of the second base body 64.

Where objects appear multiple times in the figures, in each case only one is denoted by a reference numeral.

The first base body 60 of the first bearing element 18 and the second base body 64 of the second bearing element 20 are each manufactured from a metal and/or from a metal alloy, in the present case from titanium. The first contact elements 62 of the first bearing element 18 and the second contact elements 66 of the second bearing element 20 are each formed from polycrystalline diamond. The first contact elements 62 are pressed form-fittingly and/or frictionally into corresponding recesses in the first base body 60. The second contact elements 66 are likewise pressed form-fittingly and/or frictionally into corresponding recesses in the second base body 64.

When the agitator device 10 is in the operation state, the first contact elements 62 of the first bearing element 18 and the second contact elements 66 of the second bearing element 20 are in contact with one another, wherein the second contact elements 66 of the second bearing element 20 designed as a movable inner ring 26 are moved in a rotational movement around the bearing axis 22 (cf. FIG. 3) relative to the first contact elements 62 of the as a stationary outer ring 24.

The intermediate bearing 12 is designed for dry running. During dry running, the first bearing element 18 and the second bearing element 20, specifically the first contact elements 62 of the first bearing element 18 and the second contact elements 66 of the second bearing element 20, are in direct contact, and there is solid-to-solid friction between the first contact elements 62 and the second contact elements 66. During dry running, a coefficient of friction between the first bearing element 18 and the second bearing element 20, specifically between the first contact elements 62 of the first bearing element 18 and the second contact elements 66 of the second bearing element 20, is at most 0.08.

The intermediate bearing 12 is furthermore also designed for wet running. During wet running, the intermediate bearing is hydrodynamically lubricated, specifically by the medium 32 that is situated in the agitation tank 16 (cf. FIG. 1). During wet running, a hydrodynamic lubricating film forms between the first contact elements 62 of the first bearing element 18 and the second contact elements 66 of the second bearing element 20. During wet running, the coefficient of friction between the first bearing element 18 and the second bearing element 20, specifically between the first contact elements 62 of the first bearing element 18 and the second contact elements 66 of the second bearing element 20, is at most 0.002.

The first bearing element 18 and the second bearing element 20 each have a compressive strength of at least 5 GPa. In the present case, the first bearing element 18 and the second bearing element 20 each have a compressive strength of between 6.9 GPa and 7.6 GPa. Radial forces originating from the agitation shaft 14 in the operation state can thus be reliably accommodated by the intermediate bearing 12.

The intermediate bearing 12 has a heat resistance of at least 250° C. The first bearing element 18 and the second bearing element 20, specifically in particular the first contact elements 62 of the first bearing element 18 and the second contact elements 66 of the second bearing element 20, furthermore each have a thermal conductivity of at least 400 W/mK. In the present case, the first contact elements 62 of the first bearing element 18 and the second contact elements 66 each have a thermal conductivity of 543 W/mK. Owing to the high thermal conductivities, it is possible in the operation state, specifically in particular during the starting and stoppage of the agitation shaft 14 and during dry running, to achieve effective and rapid dissipation of friction heat, such that the likelihood of undesired local friction welding between the contact elements 62, 66 of the first bearing element 18 and of the second bearing element 20, which would lead to scoring and abrasion and thus premature wear, is reduced, preferably minimized.

FIG. 5 is a schematic flow diagram of a method for operating the agitation system 30, wherein the agitation tank 16 has been filled with a corrosive and/or abrasive medium 32 and wherein the medium 32 is at a temperature of at least 180° C. The method comprises at least two method steps. In a first method step 50 of the method, the agitation system 30 is set in operation, with the agitation tank 16 being filled with the corrosive and/or abrasive medium 32 and the medium being heated to a temperature of at least 180° C. In the present case, the medium 32 is at a temperature between 190° C. and 210° C. In the case of the production of terephthalic acid, the corrosive and/or abrasive medium 32 may for example be acetic acid. In a second method step 52, the medium 32 is agitated in the agitation tank 16 by means of the agitation elements 36. For example, for the production of terephthalic acid, p-Xylene is continuously agitated with atmospheric oxygen in acetic acid as solvent at approximately 15 bar, and in the process is catalytically oxidized until terephthalic acid is precipitated in solid form.

### REFERENCE NUMERALS

10 Agitator device
12 Intermediate bearing
14 Agitation shaft
16 Agitation tank
18 First bearing element
20 Second bearing element
22 Bearing axis
24 Stationary outer ring
26 Movable inner ring
30 Agitation system
32 Medium
34 Agitator
36 Agitation element
38 Bearing housing
40 Fastening pin
42 Shaft shoulder
44 First shaft diameter
46 Second shaft diameter
48 Shaft sleeve
50 First method step
52 Second method step
54 Drive unit
56 Agitation axis
58 Fastening strut
60 First base body
62 First contact element
64 Second base body

1. An agitator device having at least one intermediate bearing which is configured for supporting an agitation shaft within an agitation tank and which has a first bearing element and a second bearing element which, in an operation state, is rotatable relative to the first bearing element around a bearing axis and is in contact with the first bearing element, wherein at least one of the bearing elements has polycrystalline diamond.

2. The agitator device as claimed in claim 1, wherein both bearing elements have polycrystalline diamond.

3. The agitator device as claimed in claim 1, wherein the intermediate bearing is designed for dry running.

4. The agitator device as claimed in claim 3, wherein a coefficient of friction between the first bearing element and the second bearing element during dry running is at most 0.08.

5. The agitator device as claimed in claim 1, wherein the first bearing element and the second bearing element have a compressive strength of at least 5 GPa.

6. The agitator device as claimed in claim 1, wherein the first bearing element and the second bearing element have a thermal conductivity of at least 400 W/mK.

7. The agitator device as claimed in claim 1, wherein the intermediate bearing has a heat resistance of at least 250° C.

8. The agitator device as claimed in claim 1, characterized in that wherein the intermediate bearing is designed as a radial bearing, wherein the first bearing element is designed as a stationary outer ring and the second bearing element is designed as a movable inner ring.

9. An agitation system, in particular reactor, having an agitation tank and having an agitator device as claimed in claim 1 arranged in the agitation tank.

10. A method for operating an agitation system as claimed in claim 9, wherein the agitation tank is filled with a corrosive and/or abrasive medium.

11. The method as claimed in claim 10, wherein the medium is at a temperature of at least 180° C.
